(19) United States
(12) Patent Application Publication
(10) Pub. No.: US 2024/0190305 A1
(43) Pub. Date: Jun. 13, 2024

(54) SEAT FOR VEHICLE AND METHOD FOR CONTROLLING THE SAME

(71) Applicants: Hyundai Motor Company, Seoul (KR); Kia Corporation, Seoul (KR)

(72) Inventors: Kug Hun Han, Seoul (KR); Sang Soo Lee, Hwaseong-si (KR); Sang Hark Lee, Incheon (KR); Dong Hoon Lee, Seoul (KR); Mun Seung Kang, Suwon-si (KR); Deok Soo Lim, Hwaseong-si (KR); Yo Han Kim, Ansan-si (KR)

(21) Appl. No.: 18/206,745

(22) Filed: Jun. 7, 2023

(30) Foreign Application Priority Data
Dec. 7, 2022 (KR) 10-2022-0169981

(51) Int. Cl. B60N 2/12; B60N 2/02

(52) U.S. Cl. CPC B60N 2/12; B60N 2/0232; B60N 2/0244

(57) ABSTRACT

A seat for a vehicle includes a reclining unit, a tilting unit, a sliding unit, and a control unit configured to control driving of the reclining unit, the tilting unit and the sliding unit. A method for controlling the seat implemented by the control unit may limit or enforce at least one of an angle adjustment amount of the tilting unit and an angle adjustment amount of the reclining unit by linking at least one of a sensed tilting angle of the seat cushion and a sensed position of the seat with a support angle of a seatback.

### CROSS-REFERENCE TO RELATED APPLICATION (S)

This application claims benefit of priority to Korean Patent Application No. 10-2022-0169981 filed on Dec. 7, 2022, in the Korean Intellectual Property Office, the disclosure of which is incorporated herein by reference in its entirety.

### TECHNICAL FIELD

The present disclosure relates to a seat for a vehicle and a method for controlling the seat by linking a tilting angle of a seat cushion and/or a sliding position of the seat with a support angle of a seatback.

### BACKGROUND

An electric seat for a vehicle may be capable of a sliding adjustment function for moving the seat forwards and backwards according to the driving purpose, a tilting adjustment function for adjusting a forward tilting angle of a seat cushion, and a reclining adjustment function for adjusting a support angle of a seatback. However, these adjustment functions may be limited by a shape of the seat or an internal shape of the vehicle, e.g., the reclining function may be limited by interference between the seat and a wheelhouse trim.

### SUMMARY

The following summary presents a simplified summary of certain features. The summary is not an extensive overview and is not intended to identify key or critical elements.

Systems, apparatuses, and methods are described for a seat or a method for controlling a seat. A seat for a vehicle may comprise a reclining unit, a tilting unit, a sliding unit and a control unit. The reclining unit may comprise a reclining adjustment motor configured to provide driving force for adjusting a support angle of a seatback and a first sensor configured to sense the support angle of the seatback. The tilting unit may comprise a tilting adjustment motor configured to provide driving force for adjusting a tilting angle of a seat cushion, and a second sensor configured to sense the tilting angle of the seat cushion. The sliding unit may comprise a sliding adjustment motor configured to provide driving force for adjusting a position of the seat in a front to rear direction, and a third sensor configured to sense the position of the seat. The control unit may be configured to control operations of at least one of the reclining unit, the tilting unit, or the sliding unit, by either limiting or enforcing at least one of an angle adjustment amount of the tilting unit or an angle adjustment amount of the reclining unit based on a relation between the support angle of the seatback and at least one of the sensed tilting angle of the seat cushion or the sensed position of the seat.

A method for controlling a seat may comprise receiving input indicating a control operation of a switch module, determining whether the control operation is an upward tilting control operation of a front portion of a seat cushion or a rear reclining control operation of a seatback, receiving information indicating a tilting angle of the seat cushion and information indicating a support angle of the seatback, determining whether a first value obtained by adding the tilting angle of the seat cushion and the support angle of the seatback is less than a first set allowable value; and, if the first value is less than the first set allowable value, allowing the control operation to be performed or, if the first value is greater than or equal to the first set allowable value, terminating the upward tilting control operation of the front portion of the seat cushion or the rear reclining control operation of the seatback.

A method for controlling a seat may comprise receiving input indicating a control operation of a switch module, determining the control operation is an upward tilting control operation of a front portion of a seat cushion or a rear reclining control operation of a seatback, receiving information indicating a tilting angle of the seat cushion and information indicating a support angle of the seatback, determining whether a first value obtained by adding the tilting angle of the seat cushion and the support angle of the seatback is less than a first set allowable value, and, based on the first value being determined to be less than the first set allowable value, allowing the control operation to be performed or, based on the first value being determined to be greater than or equal to the first set allowable value, allowing the control operation to be performed and either, if the control operation is the upward tilting control operation, performing a front reclining operation of the seatback or, if the control operation is rear reclining control operation, performing a downward tilting operation of the seat cushion.

A method for controlling a seat may comprise receiving input indicating operating of a switch module, determining whether the input indicates a rear reclining control of a seatback, based on determining that that the input indicates the rear reclining control of the seatback, receiving information on a support angle of the seatback and information on a position of the seat, determining whether the seat is within an interference range relative to a reference position, based on determining that the seat is within the interference range relative to the reference position, determining whether a second value of the support angle of the seatback is less than a third set allowable value, and, based on the second value being determined to be less than the third set allowable value, performing a rear reclining operation of the seatback or, based on the second value being determined to be greater than or equal to the third set allowable value, performing a front sliding operation of the seat along with the rear reclining operation of the seatback.

These and other features and advantages are described in greater detail below.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a view illustrating a configuration and arrangement of a motor implementing each function of an electric seat;

FIG. 2 is a schematic view for explaining a situation in which a wheelhouse trim of a vehicle body and a seatback interfere when a support angle of the seatback is adjusted rearward;

FIG. 3 is a block diagram schematically illustrating the configuration of a seat for a vehicle according to the present disclosure;

FIG. 4 is a side view for explaining an operation of the seat for a vehicle according to the present disclosure;

FIG. 5 is a flowchart of a control method according to a first example of the present disclosure;

FIG. 6 is a graph for explaining a first set allowable value in the control method according to the first example of the present disclosure;

FIGS. 7A and 7B are flowcharts of a control method according to a second example of the present disclosure;

FIGS. 8A and 8B are flowcharts of a control method according to a third example of the present disclosure;

FIGS. 9A and 9B are flowcharts of a control method according to a fourth example of the present disclosure;

FIGS. 10A and 10B are graphs for explaining a second set allowable value in the control method according to the fourth example of the present disclosure;

FIG. 11 is a flowchart of a control method according to a fifth example of the present disclosure;

FIG. 12 is a graph for explaining a third set allowable value in the control method according to the fifth example of the present disclosure; and

FIG. 13 is a flowchart of a control method according to a sixth example of the present disclosure.

### DETAILED DESCRIPTION

Hereinafter, the present disclosure will be described in detail with reference to the accompanying drawings. In adding reference numerals to elements of each of the drawings, although the same elements are illustrated in other drawings, like reference numerals may refer to like elements.

In the present disclosure, the vehicle refers to various vehicles for moving transported objects such as people or animals, things, and the like, from a departure point to a destination. Such vehicles are not limited to vehicles driving on roads or tracks.

The terms such as “first,” “second” or “third” may be used to describe various elements, but these elements are not limited in order, size, position, and importance by terms such as “first,” “second,” and “third.” The terms may be used for distinguishing one component from other components.

Detailed descriptions of concepts commonly known in the art will be omitted if such descriptions would make the description unclear.

With the advent of autonomous vehicles, the interior of the vehicle is being transformed into a concept of a moving space. To this end, a comfortable indoor environment is desired in the vehicle. This is why a seat for a vehicle should be designed more ergonomically and/or adjustable.

For example, a relaxation and/or comfortable posture may be implemented for the seat. Here, the relaxation comfort and/or comfortable posture refers to a posture in which a passenger's body pressure can be maximally distributed while the passenger is seated on the seat 1 so that he or she may feel comfortable and relaxed.

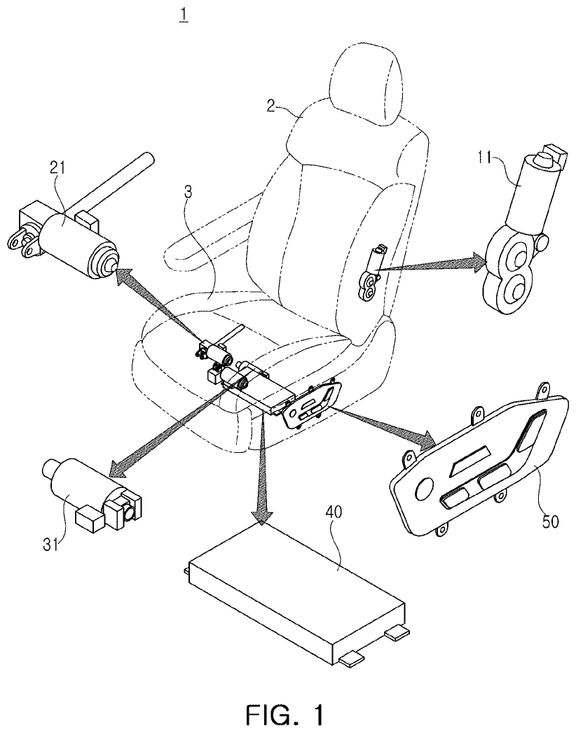

In order to realize each of a sliding adjustment function, a tilting adjustment function, and a reclining adjustment function of the seat, as illustrated in FIG. 1, a sliding adjustment motor 31, a tilting adjustment motor 21, and a reclining adjustment motor 11 may be individually mounted in an internal frame of the seat 1. When a passenger operates a switch module 50, sliding, tilting, and/or reclining functions may be implemented via the control of motors thereof by a control unit 40, thereby allowing the passenger to have a comfortable posture while seated in the seat 1.

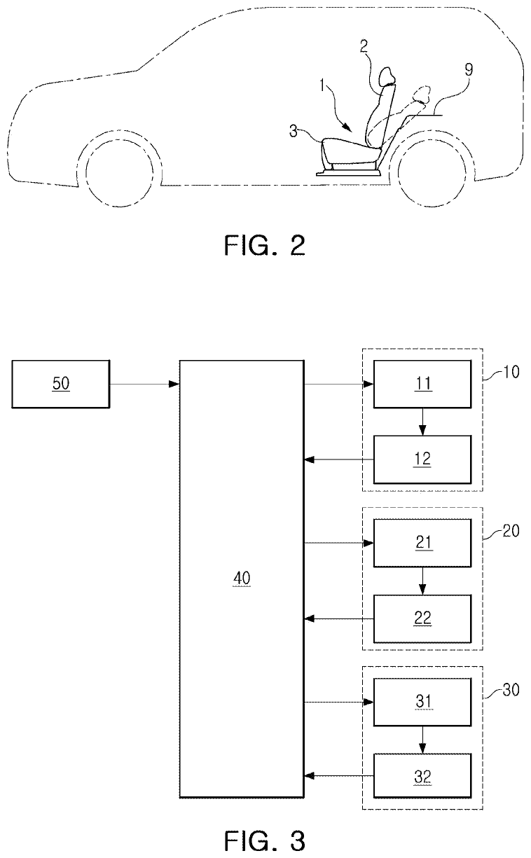

When adjusting the support angle of a seatback 2 backward, a wheelhouse trim 9 of the vehicle body protruding into an interior may interfere with the seatback 2, as illustrated in FIG. 2. In order to prevent such interference, the interference portion of the seatback 2 may be curved, removed and/or designed around by changing a shape of the seatback 2, or angle adjustment may be limited when the seatback 2 is reclining.

However, if the shape of the seatback 2 is changed and/or designed to accommodate reclining/tilting/moving interfering structures in the vehicle, it may be difficult to secure an original function of the seatback 2, e.g., to comfortably and fully support a passenger's back. In addition, when the angle adjustment is excessively limited during reclining, the marketability of the seat 1 may be reduced.

For this reason, tilting and/or height adjustment of a seat cushion 3 may be applied to the seat 1 together (e.g., in coordination). In this case, when an angle of the seat cushion 3 is adjusted, a position of a hinge, which is the center of rotation of a seatback 2, may be changed, and accordingly, when adjusting the seatback 2, a position and a support angle of the seatback 2 change according to a tilting angle of the seat cushion 3.

Accordingly, in order to prevent interference between the wheelhouse trim and the seatback, unlike conventional technology, there is a need for a technique to limit the adjustment amount of the support angle of the seatback according to the condition in which the passenger adjusts the tilting of the seat cushion and the position of the seat.

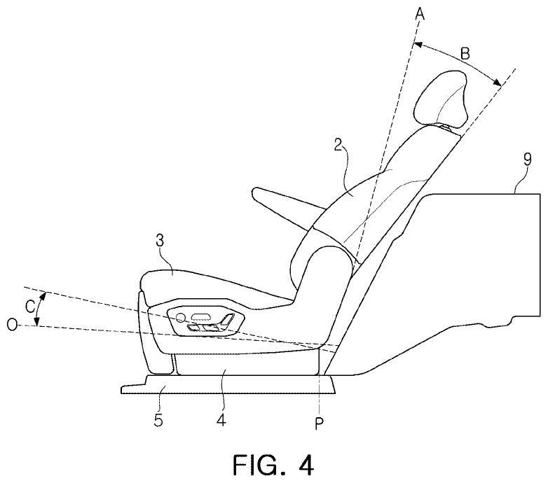

FIG. 3 is a block diagram schematically illustrating the configuration of a seat for a vehicle according to the present disclosure, and FIG. 4 is a side view for explaining an operation of the seat for a vehicle according to the present disclosure.

The seat for a vehicle according to the present disclosure may include a reclining unit 10, a tilting unit 20, a sliding unit 30, and/or a control unit 40.

In addition, or alternatively, the seat for a vehicle according to the present disclosure may further include a switch module 50 that may be operable by a passenger to control an operation of at least one of a reclining unit 10, a tilting unit 20, and/or a sliding unit 30. The switch module may be disposed in an interior of the vehicle, specifically, on one side surface of the seat (see FIG. 1), and may be communicatively connected (e.g., electrically connected) to and configured to communicate with the control unit 40 in a wired manner and/or a wireless manner.

The reclining unit 10 may control a support angle B of a seatback 2 in response to a control operation (e.g., a reclining control operation) input via the switch module 50 (e.g., by the passenger).

The reclining unit 10 may include a reclining adjustment motor 11 configured to provide driving force for adjusting the support angle B of the seatback 2 and a first sensor 12 configured to sense the support angle B of the seatback and transmit the support angle to the control unit 40.

The reclining adjustment motor 11 may be, for example, a servo motor or a step motor capable of forward and/or reverse rotation. In addition, or alternatively, a hall sensor installed in the reclining adjustment motor may be adopted as the first sensor 12.

An operation of the reclining adjustment motor 11 may be controlled by the control unit 40, and the number of rotations of the reclining adjustment motor may be sensed by the first sensor 12, and information on the support angle B of the seatback 2 may be transmitted to the control unit 40.

For convenience of explanation, and as shown in FIG. 4, the support angle B of the seatback 2 is an angle at which the seatback rotates rearward around a hinge connecting the seat cushion frame and the seatback from a reference angle A extended from a seat cushion frame to a designated seating angle.

The reclining unit 10 may be connected to a recliner via, for example, a power transmission mechanism and/or a shaft. The recliner may be configured to rotate the seatback 2 relative to a seat cushion 3 so that the support angle B of the seatback relative to the seat cushion 3 may be adjusted forwards or backwards.

The tilting unit 20 may control a tilting angle C of the seat cushion 3 in response to a control operation (e.g., a tilting control operation) input via the switch module 50 (e.g., by the passenger).

The tilting unit 20 may include a tilting adjustment motor 21 configured to provide driving force for adjusting the tilting angle C of the seat cushion 3, and/or a second sensor 22 configured to sense the tilting angle of the seat cushion and transmit the tilting angle to the control unit 40.

The tilting adjustment motor 21 may be, for example, a servo motor or a step motor capable of forward and reverse rotation. In addition, or alternatively, a hall sensor installed in the tilting adjustment motor may be adopted as the second sensor 22.

An operation of the tilting adjustment motor 21 may be controlled by the control unit 40, and the number of rotations of the tilting adjustment motor may be sensed by the second sensor 22, and information on the tilting angle C of the seat cushion 3 may be transmitted to the control unit 40.

For convenience of explanation, the tilting angle C of the seat cushion 3, illustrated in FIG. 4, is an angle at which the front portion of the seat cushion 3 rotates around a rear hinge or a hinge at a moving rail 4 of a rear link, which connects the moving rail 4 and the seat cushion 3 described below. However, the tilting angle of the seat cushion 3 is not necessarily limited thereto, and may denote an angle at which a rear portion of the seat cushion rotates around an opposite hinge.

The tilting unit 20 may be connected to at least one link via, for example, a lead screw and/or gear. The link may be interposed between the moving rail 4 and the seat cushion 3 and/or may be configured to rotate relative to the moving rail 4. Accordingly, for example, a height of the front portion of the seat cushion 3 may increase or decrease to tilt the seat cushion 3.

Any suitable link mechanism of various configurations installed between the moving rail 4 and the seat cushion 3 may be implemented.

The sliding unit 30 may control the front and rear positions of the seat in response to a control operation (e.g., a sliding control operation) input via the switch module 50 (e.g., via the passenger).

The sliding unit 30 may include a sliding adjustment motor 31 configured to provide driving force for adjusting the front and rear positions of the seat 1, and a third sensor 32 configured to sense the position of the seat 1 and transmit the position of the seat 1 to the control unit 40.

The sliding adjustment motor 31 may be, for example, a servo motor or a step motor capable of forward and reverse rotation. In addition, or alternatively, a hall sensor installed in the sliding adjustment motor may be adopted as the third sensor 32.

An operation of the sliding adjustment motor 31 may be controlled by the control unit 40, and the number of rotations of the sliding adjustment motor may be sensed by the third sensor 32, and information on the position of the seat may be transmitted to the control unit 40.

For convenience of description, the position of the seat 1 is described and illustrated as a forward advance distance in which the seat moves forward with respect to a position at which the seat 1 reaches a rearmost position by sliding as a reference position P.

The sliding unit 30 may be connected to the moving rail 4 on a support rail 5 via, for example, power transmission mechanisms as a lead screw and a gear, or a rack and a pinion. The support rail may be fixedly mounted to a floor panel inside the vehicle, and the moving rail 4 may be installed on the support rail 5 so as to slide forwards and backwards in the longitudinal direction of the support rail 5.

The link mechanism may be interposed between the moving rail 4 and the seat cushion 3 so that the moving rail and the seat cushion may be connected to each other. As the moving rail 4 slides forwards and backwards on the support rail 5, the front and rear positions of the seat 1 including the seat cushion 3 and the seatback 2 may be changed.

Various configurations of moving rails 4 and/or power transmission mechanisms may be implemented.

The first sensor 12, the second sensor 22, and the third sensor 32 may include the hall sensors installed in each motor. That is, the first sensor 12 may be a hall sensor installed in the reclining adjustment motor 11, the second sensor 22 may be the hall sensor installed in the tilting adjustment motor 21, and the third sensor 32 may be the hall sensor installed in the sliding adjustment motor 31.

Accordingly, the sensors 12, 22 and/or 32 may be configured to sense the support angle B of the seatback 2, the tilting angle C of the seat cushion 3, and the front and rear positions of the seat 1, respectively, and transmit the corresponding information to the control unit 40.

The control unit 40 may control the operation of at least one of the reclining unit 10, the tilting unit 20, and the sliding unit 30 according to the corresponding control operation input via the switch module 50. In addition, or alternatively, the control unit 40 may limit or enforce the angle adjustment amount of the tilting unit 20 or the angle adjustment amount of the reclining unit 10 by linking tilting angle C of the seat cushion 3 and/or the position of the seat 1 sensed by the corresponding sensor with the support angle B of the seatback 2.

The control unit 40 may be communicatively connected to the reclining adjustment motor 11 and the first sensor 12, the tilting adjustment motor 21 and the second sensor 22, and the sliding adjustment motor 31 and the third sensor 32 via, for example, at least one of wired communication and/or wireless communication.

The control unit 40 may be implemented as a computing device having a processor (e.g., a microprocessor) and/or a memory. The memory may store information sensed from each of the sensors and instructions for performing the control operations. The processor may execute the stored instructions to control the operation of one of the reclining unit 10, the tilting unit 20, and the sliding unit 30 according to a control operation signal input via the switch module 50. The processor may also execute the instructions to determine whether to allow an angle adjustment of the tilting unit 20 or an angle adjustment of the reclining unit 10, by using information stored in the memory, and may control or limit the operation of the tilting unit or reclining unit according to the results of the determination.

In addition, or alternatively, the control unit 40 may be merged into or used in, for example, an electronic control unit (ECU) of a vehicle. Alternatively, the control unit may be electrically and/or communicatively connected to an upper control system of the vehicle, thus providing detected information.

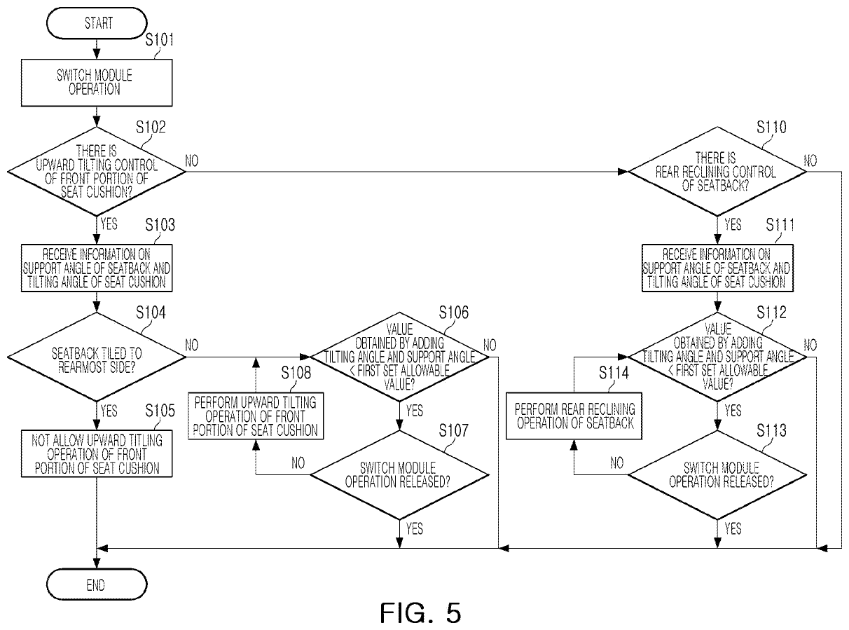

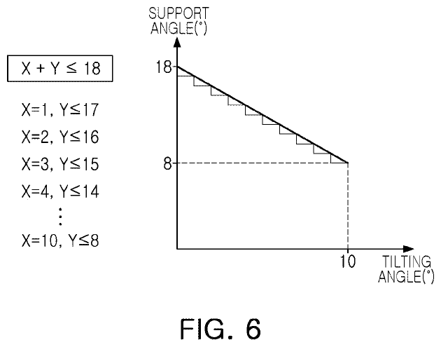

FIG. 5 is a flowchart of a control method according to a first example of the present disclosure, and FIG. 6 is a graph for explaining a first set allowable value in the control method according to the first example of the present disclosure

The control method according to the first example of the present disclosure may limit the angle adjustment amount of the tilting unit 20 or the angle adjustment amount of the reclining unit 10 by linking the tilting angle C of the seat cushion 3 with the support angle B of the seatback 2. In other words, the tilting unit 20 and the reclining unit 10 may not operate and may be restricted even if the passenger operates the switch in the switch module 50, except in an operable region.

To this end, the control unit 40 may match and preset a maximum support angle for rear reclining of the seatback 2 corresponding to the tilting angle C of the seat cushion 3 of a predetermined unit.

In this state, for example, when the passenger operates the switch module 50 to perform rear reclining control of the seatback 2, the control unit 40 may control an operation of a reclining adjustment motor 11 of the reclining unit 10 within the maximum support angle for rear reclining of the seatback 2 matched to the tilting angle C of the seat cushion 3 sensed by the second sensor 22 of the tilting unit 20.

For example, as illustrated in FIG. 6, if the front portion of the seat cushion 3 is in a lowermost position O (see FIG. 4) and has the tilting angle of 0°, the seatback 2 may be tilted at a maximum support angle B of 18° rearward from the reference angle A. In addition, or alternatively, if the front portion of the seat cushion 3 is in an uppermost position and has the tilting angle of 10°, the seatback 2 may be tilted at a maximum support angle B of 8° rearward from the reference angle A, that is, at a support angle reduced by approximately 10° as compared to the maximum angle adjustment.

The relationship may be expressed in a mathematical equation below.

X+Y≤18 <Equation 1>

Here, X is a value of the tilting angle (°) of the seat cushion 3 and is within the range of 0≤x≤10, and Y is a value of the support angle (°) from the reference angle of the seatback 2 and is within the range of 0≤Y≤18. Hereinafter, 18 is referred to as a first set allowable value.

As illustrated in FIG. 5, when the passenger operates the switch module 50 (S101), a control operation signal may be input to the control unit 40.

If the control operation of the passenger is input to the control unit 40, the control unit 40 may preferentially determine whether the input control operation is upward tilting control of the front portion of the seat cushion 3 (S102).

If it is determined that the input control operation is upward tilting control of the front portion of the seat cushion 3, the control unit 40 may receive information on the support angle B of the seatback 2 from the first sensor 12 of the reclining unit 10 and information on the tilting angle C of the seat cushion 3 from the second sensor 22 of the tilting unit 20 (S103), and may confirm whether the seatback 2 is tilted from the reference angle A to a rearmost side (S104).

For example, if the seatback 2 is tilted from the reference angle A to the rearmost side, the support angle B may be 18°. In other words, the support angle if the seatback 2 is tilted from the reference angle to the rearmost side may be an angle having the first set allowable value.

If it is confirmed that the seatback 2 is tilted from the reference angle A to the rearmost side, the control unit 40 may not allow an upward tilting operation of the front portion of the seat cushion 3 without allowing an operation of the tilting adjustment motor 21 of the tilting unit 20 (S105).

If the seatback 2 is not tilted from the reference angle A to the rearmost side, the control unit 40 may determine whether the first value obtained by adding the tilting angle C of the seat cushion 3 and the support angle B of the seatback 2 is less than the first set allowable value (S106).

If the first value obtained by adding the tilting angle C of the seat cushion 3 and the support angle B of the seatback 2 is less than the first set allowable value, the control unit 40 may confirm whether the operation of the switch module 50 is released (S107). While the operation of the switch module 50 is maintained, the control unit 40 may perform the upward tilting operation of the front portion of the seat cushion 3 by allowing the operation of the tilting adjustment motor 21 (S108).

In this case, the control unit 40 may count the number of rotations of the tilting adjustment motor 21 sensed by the second sensor 22 to calculate the angle adjustment amount of the tilting angle C of the seat cushion 3 as well as to update information on the tilting angle of the seat cushion 3.

If the operation of the switch module 50 is released, the control unit 40 may terminate the upward tilting control of the front portion of the seat cushion 3.

In addition, or alternatively, if the first value obtained by adding the tilting angle C of the seat cushion 3 and the support angle B of the seatback 2 is greater than or equal to the first set allowable value, the control unit 40 may terminate the upward tilting control of the front portion of the seat cushion 3.

If it is determined that the input control operation is not the upward tilting control of the front portion of the seat cushion 3, the control unit 40 may determine whether the input control operation is rear reclining control of the seatback 2 (S110).

If it is determined that the input control operation is the rear reclining control of the seatback 2, the control unit 40 may receive information on the support angle B of the seatback 2 from the first sensor 12 of the reclining unit 10 and information on the tilting angle C of the seat cushion 3 from the second sensor 22 of the tilting unit 20.

The control unit 40 may determine whether the first value obtained by adding the support angle B of the seatback 2 and the tilting angle C of the seat cushion 3 is less than the first set allowable value (S112).

If the first value obtained by adding the support angle B of the seatback 2 and the tilting angle C of the seat cushion 3 is less than the first set allowable value, the control unit 40 may confirm whether the operation of the switch module 50 is released (S113). If the operation of the switch module is maintained, the control unit 40 may perform the rear reclining operation of the seatback 2 by allowing the operation of the reclining adjustment motor 11 (S114).

In this case, the control unit 40 may count the number of rotations of the reclining adjustment motor 11 sensed by the first sensor 12 to calculate the angle adjustment amount of the support angle B of the seatback 2 as well as to update information on the support angle B of the seatback 2.

If the operation of the switch module 50 is released, the control unit 40 may terminate the rear reclining control of the seatback 2.

In addition, or alternatively, if the first value obtained by adding the support angle B of the seatback 2 and the tilting angle C of the seat cushion 3 is greater than or equal to the first set allowable value, the control unit 40 may terminate the rear reclining control of the seatback 2.

As described above, in accordance with the control method according to the first example of the present disclosure, the reclining control and the tilting control of the seat 1 for a vehicle may be configured to be linked with each other, and each of the operation processes may be sequentially or separately performed to limit the angle adjustment amount performed by the tilting unit 20 or the angle adjustment amount performed by the reclining unit 10.

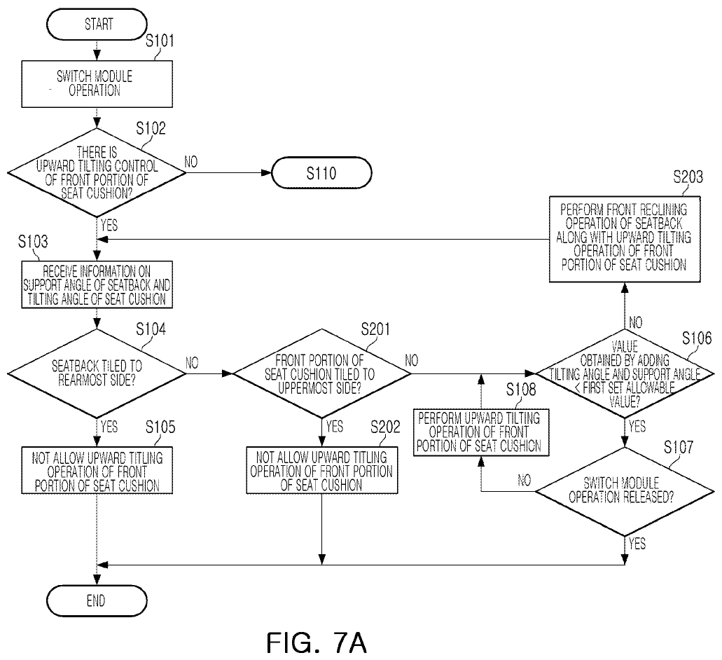

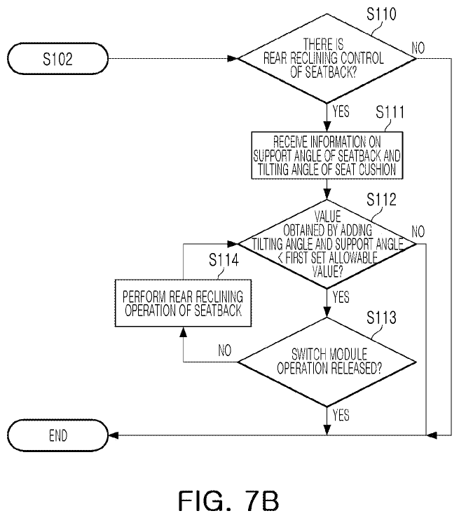

FIGS. 7A and 7B are flowcharts of a control method according to a second example of the present disclosure.

The control method according to the second example of the present disclosure may assign a priority to tilting control if the upward tilting control of the front portion of the seat cushion 3 is limited, e.g., in a state in which the seatback 2 is tilted backward. In other words, depending on the priority, since the reclining unit 10 may be forcibly operated so as to maintain the operation of the tilting unit 20, the seatback 2 may be moved forward.

The control method according to the second example of the present disclosure illustrated in FIGS. 7A and 7B is different from the control method according to the first example illustrated in FIG. 5 in that the control method in FIGS. 7A and 7B further includes: confirming whether the front portion of the seat cushion 3 is tilted to an uppermost side; and performing, by the control unit 40, a front reclining operation of the seatback 2 along with the upward tilting operation of the front portion of the seat cushion 3 if the first value obtained by adding the tilting angle C of the seat cushion 3 and the support angle B of the seatback 2 is greater than or equal to the first set allowable value. The other constitutions of the control method in FIGS. 7A and 7B are the same as the control method according to the first example illustrated in FIG. 5.

Accordingly, in describing the control method according to the second example of the present disclosure, details of the same operation as the control method according to the first example as described above will be omitted and primarily different operations will be described.

If it is determined that the control operation input via the switch module 50 is the upward tilting control of the front portion of the seat cushion 3, the control unit 40 may receive information on the support angle B of the seatback 2 from the first sensor 12 of the reclining unit 10 and information on the tilting angle C of the seat cushion 3 from the second sensor 22 of the tilting unit 20 (S103), and may confirm whether the seatback 2 is tilted from the reference angle A to the rearmost side (S104).

If it is confirmed that the seatback 2 is tilted from the reference angle A to the rearmost side, the control unit 40 may not allow the upward tilting operation of the front portion of the seat cushion 3 without allowing the operation of the tilting adjustment motor 21 of the tilting unit 20 (S105).

If the seatback 2 is not tilted from the reference angle A to the rearmost side, the control unit 40 may confirm whether the front portion of the seat cushion 3 is tilted to the uppermost side (e.g., tilted upward to a maximum angle C) (S201).

If it is confirmed that the front portion of the seat cushion 3 is tilted to the uppermost side, the control unit 40 may not allow the upward tilting operation of the front portion of the seat cushion 3 without allowing the operation of the tilting adjustment motor 21 of the tilting unit 20 (S202).

If the front portion of the seat cushion 3 is not tilted to the uppermost side, the control unit 40 may determine whether the first value obtained by adding the tilting angle C of the seat cushion 3 and the support angle B of the seatback 2 is less than the first set allowable value (S106).

If the first value obtained by adding the tilting angle C of the seat cushion 3 and the support angle B of the seatback 2 is less than the first set allowable value, the control unit 40 may confirm whether the operation of the switch module 50 is released (S107). If the operation of the switch module is maintained, the control unit 40 may perform the upward tilting operation of the front portion of the seat cushion 3 by allowing the operation of the tilting adjustment motor 21 (S108).

In this case, the control unit 40 may count the number of rotations of the tilting adjustment motor 21 detected by the second sensor 22 to calculate the angle adjustment amount of the tilting angle C of the seat cushion 3 as well as to update information on the tilting angle C of the seat cushion 3.

If the operation of the switch module 50 is released, the control unit 40 may terminate the upward tilting control of the front portion of the seat cushion 3.

In addition, or alternatively, if the first value obtained by adding the tilting angle C of the seat cushion 3 and the support angle B of the seatback 2 is greater than or equal to the first set allowable value, the control unit 40 may perform the front reclining operation of the seatback 2 by enforcing the operation of the reclining adjustment motor 11, along with the upward tilting motion of the front portion of the seat cushion by allowing the operation of the tilting adjustment motor 21 (S203).

The control unit 40 may repeat control from the operation S103 of receiving the information on the support angle B of the seatback 2 from the first sensor 12 of the reclining unit 10 and the information on the tilting angle C of the seat cushion 3 from the second sensor 22 of the tilting unit 20.

As described above, in accordance with the control method according to the second example of the present disclosure, since the reclining control and the tilting control of the seat 1 for a vehicle are configured to be linked with each other, the angle adjustment amount of the reclining unit 10 may be enforced according to the angle adjustment amount of the tilting unit 20.

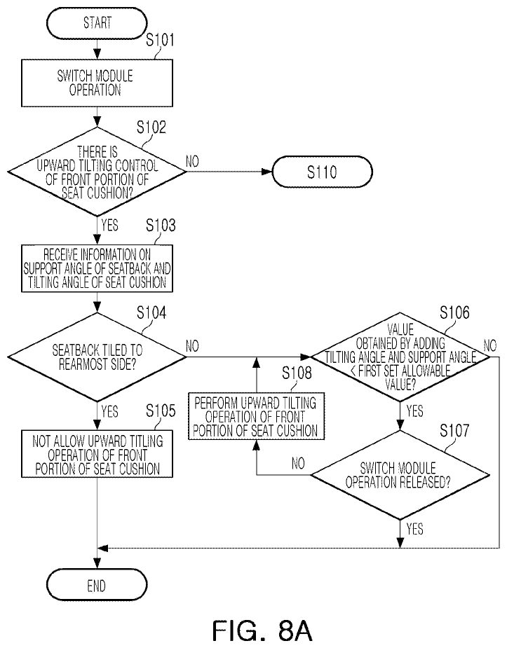

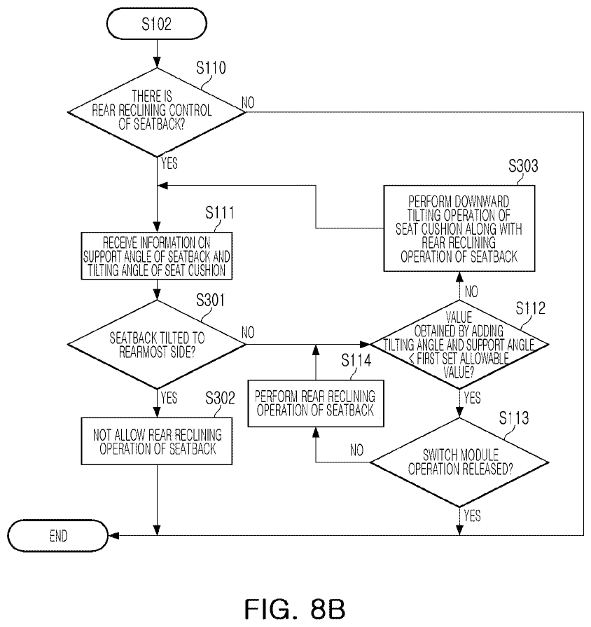

FIGS. 8A and 8B are flowcharts of a control method according to a third example of the present disclosure.

The control method according to the third example of the present disclosure may assign a priority to the reclining control if the rear reclining control of the seatback 2 is limited in a state in which the front portion of the seat cushion 3 is tilted upward. In other words, depending on the priority, since the tilting unit 20 may be forcibly operated so as to maintain the operation of the reclining unit 10, the front portion of the seat cushion 3 may be moved downward.

The control method according to the third example of the present disclosure illustrated in FIGS. 8A and 8B is different the control method according to the first example illustrated in FIG. 5 in that the control method in FIGS. 8A and 8B further includes: confirming whether the seatback 2 is tilted from the reference angle A to the rearmost side upon the rear reclining control of the seatback 2; and performing, by the control unit 40, a downward tilting operation of the seat cushion 3 along with the rear reclining operation of the seatback 2 if the first value obtained by adding the support angle B of the seatback 2 and the tilting angle C of the seat cushion 3 is greater than or equal to the first set allowable value. The other constitutions of the control method in FIGS. 8A and 8B are the same as the control method according to the first example illustrated in FIG. 5.

Accordingly, in describing the control method according to the third example of the present disclosure, details of the same operation as the control method according to the first example as described above will be omitted and different operations will mainly be described.

If it is determined that the control operation input via the switch module 50 is the rear reclining control of the seatback 2, the control unit 40 may receive the information on the support angle B of the seatback 2 from the first sensor 12 of the reclining unit 10 and the information on the tilting angle C of the seat cushion 3 from the second sensor 22 of the tilting unit 20 (S111), and may confirm whether the seatback 2 is tilted from the reference angle A to the rearmost side (S301).

If it is confirmed that the seatback 2 is tilted from the reference angle A to the rearmost side, the control unit 40 may not allow the rear reclining operation of the seatback 2 without allowing the operation of the reclining adjustment motor 11 of the reclining unit 10.

If the seatback 2 is not tilted from the reference angle A to the rearmost side, the control unit 40 may determine whether the first value obtained by adding the support angle B of the seatback 2 and the tilting angle C of the seat cushion 3 is less than the first set allowable value (S112).

If the first value obtained by adding the support angle B of the seatback 2 and the tilting angle C of the seat cushion 3 is less than the first set allowable value, the control unit 40 may confirm whether the operation of the switch module 50 is released (S113). If the operation of the switch module is maintained, the control unit 40 may perform the rear reclining operation of the seatback 2 by allowing the operation of the reclining adjustment motor 11 (S114).

In this case, the control unit 40 may count the number of rotations of the reclining adjustment motor 11 sensed by the first sensor 12 to calculate the angle adjustment amount of the support angle B of the seatback 2 as well as to update the information on the support angle B of the seatback 2.

If the operation of the switch module 50 is released, the control unit 40 may terminate the rear reclining control of the seatback 2.

In addition, or alternatively, if the first value obtained by adding the support angle B of the seatback 2 and the tilting angle C of the seat cushion 3 is greater than or equal to the first set allowable value, the control unit 40 may perform the downward tilting operation of the seat cushion 3 by enforcing the operation of the tilting adjustment motor 21, along with the rear reclining operation of the seatback 2 by allowing the operation of the reclining adjustment motor 11 (S303).

The control unit 40 may repeat control from the operation S111 of receiving the information on the support angle B of the seatback 2 from the first sensor 12 of the reclining unit 10 and the information on the tilting angle C of the seat cushion 3 from the second sensor 22 of the tilting unit 20.

As described above, in accordance with the control method according to the third example of the present disclosure, since the reclining control and the tilting control of the seat for a vehicle are configured to be linked with each other, the angle adjustment amount of the tilting unit 20 may be enforced according to the angle adjustment amount of the reclining unit 10.

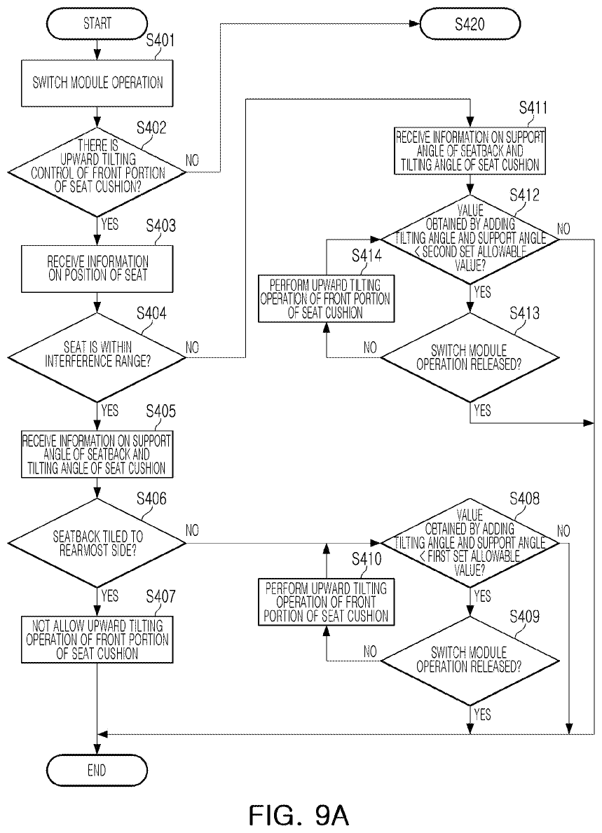

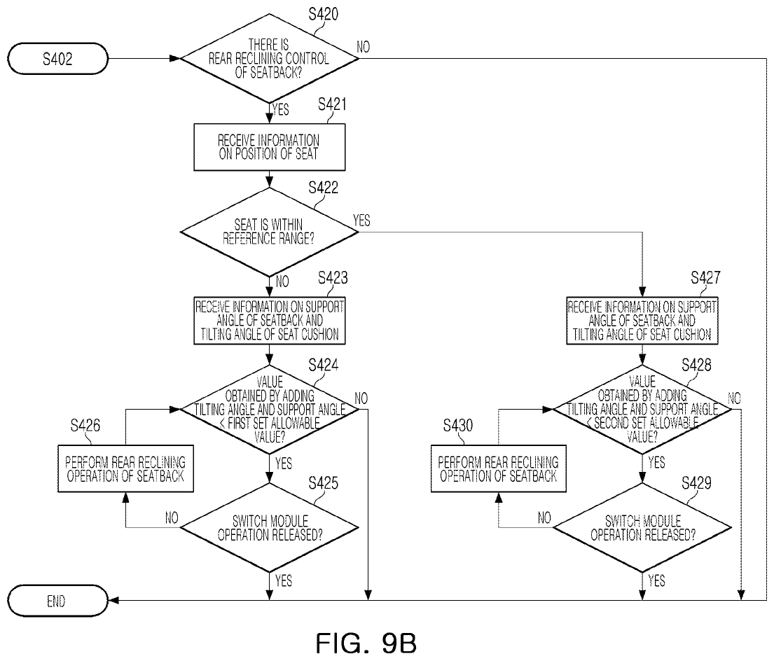

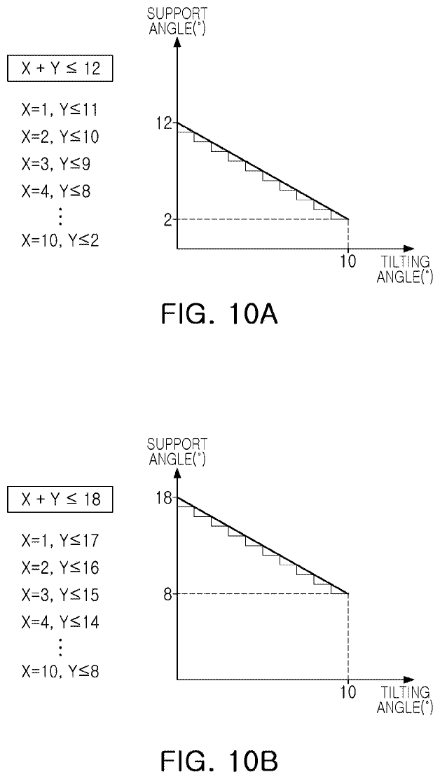

FIGS. 9A and 9B are flowcharts of a control method according to a fourth example of the present disclosure, and FIGS. 10A and 10B are graphs for explaining a second set allowable value in the control method according to the fourth example of the present disclosure.

The control method according to the fourth example of the present disclosure may limit the angle adjustment amount of the tilting unit 20 or the angle adjustment amount of the reclining unit 10 by linking the tilting angle C of the seat cushion 3 and the sliding position of the seat with the support angle B of the seatback 2. In other words, the tilting unit 20 and the reclining unit 10 may not operate and may be restricted even if the passenger operates the switch in the switch module 50, except in the operable region.

To this end, first, the control unit 40 may match and preset a maximum support angle for rear reclining of the seatback 2 corresponding to the tilting angle C of the seat cushion 3 of the predetermined unit and the position of the seat of the predetermined unit.

In this state, for example, if the passenger operates the switch module 50 to perform the rear reclining control of the seatback 2, the control unit 40 may control the operation of the reclining adjustment motor 11 of the reclining unit 10 within the maximum support angle for rear reclining of the seatback 2 matched to the tilting angle C of the seat cushion 3 sensed from the second sensor 22 of the tilting unit 20 and the position of the seat sensed from the third sensor 32 of the sliding unit 30.

For example, as illustrated in FIG. 10A, if the seat is disposed in the rearmost side and the front portion of the seat cushion 3 is disposed in the lowermost position, and the tilting angle is 0°, the seatback 2 may be tilted at a maximum support angle B of 12° rearward from the reference angle A. In addition, or alternatively, if the seat is disposed in the rearmost side and the front portion of the seat cushion 3 is disposed in the uppermost position, and the tilting angle is 10°, the seatback 2 may be tilted rearward from the reference angle at a maximum support angle of 2°, that is, the support angle reduced by approximately 10° as compared to the maximum angle adjustment amount.

The relationship may be expressed in a mathematical equation below.

X+Y≤12 <Equation 2>

In addition, or alternatively, as illustrated in FIG. 10B, if the seat is moved and disposed by 30 mm forward from the rearmost side and the front portion of the seat cushion 3 is disposed in the lowermost position, and the tilting angle is 0°, the seatback 2 may be titled at a maximum support angle B of 18° rearward from the reference angle A. In addition, or alternatively, if the seat is moved and disposed by 30 mm forward from the rearmost side and the front portion of the seat cushion 3 is disposed in the uppermost position, and the tilting angle is 10°, the seatback 2 may be titled may be titled rearward from the reference angle at a maximum support angle of 8°. The relationship may be expressed in a mathematical equation below.

X+Y≤18 <Equation 3>

Combining Equation 2 and Equation 3 according to a forward advance distance, the combination result may be expressed by the following equation.

X+Y≤{−(Z/5)+12} <Equation 4>

Here, X is a value of a tilting angle (°) of the seat cushion 3 and is within the range of 0≤x≤10, Y is a value of a support angle (°) from the reference angle of the seatback 2 and is within the range of 0≤Y≤18, and Z is a value of a forward advance distance (mm) from a reference position P as a rearmost position of the seat and is within the range of −30≤Z≤0. Hereinafter, {−(Z/5)+12} is referred to as a second set allowable value, and a range of −30≤Z≤0 is referred to as an interference range.

If the seat is advanced forward by more than 30 mm from the rearmost side and deviates from the interference range, for example, since a space between the seatback 2 and a wheelhouse trim 9 of a vehicle body protruding inward may be sufficiently separated, in this case, X and Y may be subject to the relationship of Equation 1 independent of the position of the seat, that is, the first set allowable value.

As illustrated in FIGS. 9A and 9B, as the passenger operates the switch module 50 (S401), a control operation signal may be input to the control unit 40.

If the control operation of the passenger is input to the control unit 40, the control unit 40 may preferentially determine whether the input control operation is upward tilting control of the front portion of the seat cushion 3 (S402).

If it is determined that the input control operation is the upper tilting control of the front portion of the seat cushion 3, the control unit 40 may receive information on the position of the seat from the third sensor 32 of the sliding unit 30 (S403) and confirm whether the seat is within the interference range from the reference position P as the rearmost position (S404).

For example, a distance within the interference range may be a distance up to 30 mm forward from the reference position P.

If it is confirmed that the seat deviates from the interference range from the reference position P, the control unit 40 may receive the information on the support angle B of the seatback 2 from the first sensor 12 of the reclining unit 10 and the information on the tilting angle C of the seat cushion 3 from the second sensor 22 of the tilting unit 20 (S405) and confirm whether the seatback 2 is tilted from the reference angle A to the rearmost side (S406).

In this case, if the seatback 2 is tilted from the reference angle A to the rearmost side, the support angle B may be 18°. In other words, if the support angle B of the seatback 2 is irrelevant to the position of the seat, the support angle B if the seatback 2 is reclined from the reference angle to the rearmost side may be an angle having the first set allowable value.

If it is confirmed that the seatback 2 is tilted from the reference angle A to the rearmost side, the control unit 40 may not allow the upward tilting operation of the front portion of the seat cushion 3 without allowing the operation of the tilting adjustment motor 21 of the tilting unit 20 (S407).

If the seatback 2 is not tilted from the reference angle A to the rearmost side, the control unit 40 may determine whether the first value obtained by adding the tilting angle C of the seat cushion 3 and the support angle B of the seatback 2 is less than the first set allowable value (S408).

If the first value obtained by adding the tilting angle C of the seat cushion 3 and the support angle B of the seatback 2 are less than the first set allowable value, the control unit 40 may confirm whether the operation of the switch module 50 is released (S409). If the operation of the switch module is maintained, the control unit 40 may perform the upward tilting operation of the front portion of the seat cushion 3 by allowing the operation of the tilting adjustment motor 21 (S410).

In this case, the control unit 40 may count the number of rotations of the tilting adjustment motor 21 sensed by the second sensor 22 to calculate the angle adjustment amount of the tilting angle C of the seat cushion 3 as well as to update the information on the tilting angle of the seat cushion 3.

If the operation of the switch module 50 is released, the control unit 40 may terminate the upward tilting control of the front portion of the seat cushion 3.

In addition, or alternatively, if the first value obtained by adding the tilting angle C of the seat cushion 3 and the support angle B of the seatback 2 is greater than or equal to the first set allowable value, the control unit 40 may terminate the upward tilting control of the front portion of the seat cushion 3.

Meanwhile, if it is confirmed that the seat is within the interference range from the reference position P, the control unit 40 may receive the information on the support angle B of the seatback 2 from the first sensor 12 of the reclining unit 10 and the information on the tilting angle C of the seat cushion 3 from the second sensor 22 of the tilting unit 20 (S411).

The control unit 40 may determine whether the first value obtained by adding the tilting angle C of the seat cushion 3 and the support angle B of the seatback 2 is less than the second set allowable value (S412).

If the first value obtained by adding the tilting angle C of the seat cushion 3 and the support angle B of the seatback 2 is less than the second set allowable value, the control unit 40 may confirm whether the operation of the switch module 50 is released (S413). If the operation of the switch module is maintained, the control unit 40 may perform the upward tilting operation of the front portion of the seat cushion 3 by allowing the operation of the tilting adjustment motor 21 (S414).

In this case, the control unit 40 may count the number of rotations of the tilting adjustment motor 21 sensed by the second sensor 22 to calculate the angle adjustment amount of the tilting angle C of the seat cushion 3 as well as to update the information on the tilting angle of the seat cushion.

If the operation of the switch module 50 is released, the control unit 40 may terminate the upward tilting control of the front portion of the seat cushion 3.

In addition, or alternatively, if the first value obtained by adding the tilting angle C of the seat cushion 3 and the support angle B of the seatback 2 is greater than or equal to the second set allowable value, the control unit 40 may terminate the upward tilting control of the front portion of the seat cushion 3.

Next, if it is determined that the input control operation is not the upward tilting control of the front portion of the seat cushion 3, the control unit 40 may determine whether the input control operation is the rear reclining control of the seatback 2 (S420).

If it is determined that the input control operation is the rear reclining control of the seatback 2, the control unit 40 may receive the information on the position of the seat from the third sensor 32 of the sliding unit 20 (S421), and may confirm whether the seat is within the interference range from the reference position P as the rearmost position (S422).

For example, the distance within the interference range may be a distance up to 30 mm forward from the reference position P.

If it is confirmed that the seat deviates from the interference range from the reference position P, the control unit 40 may receive the information on the support angle B of the seatback 2 from the first sensor 12 of the reclining unit 10 and the information on the tilting angle C of the seat cushion 3 from the second sensor 22 of the tilting unit 20 (S423).

The control unit 40 may determine whether the first value obtained by adding the support angle B of the seatback 2 and the tilting angle C of the seat cushion 3 is less than the first set allowable value (S424).

If the first value obtained by adding the support angle B of the seatback 2 and the tilting angle C of the seat cushion 3 is less than the first set allowable value, the control unit 40 may confirm whether the operation of the switch module 50 is released (S425), and then, if the operation of the switch module is maintained, the control unit 40 may perform the rear reclining operation of the seatback 2 by allowing the operation of the reclining adjustment motor 11 (S426).

In this case, the control unit 40 may count the number of rotations of the reclining adjustment motor 11 sensed by the first sensor 12 to calculate the angle adjustment amount of the support angle B of the seatback 2 as well as to update the information on the support angle B of the seatback 2.

If the operation of the switch module 50 is released, the control unit 40 may terminate the rear reclining control of the seatback 2.

In addition, or alternatively, if the first value obtained by adding the support angle B of the seatback 2 and the tilting angle C of the seat cushion 3 is greater than or equal to the first set allowable value, the control unit 40 may terminate the rear reclining control of the seatback 2.

Meanwhile, if it is confirmed that the seat is within the interference range from the reference position P, the control unit 40 may receive the information on the support angle B of the seatback 2 from the first sensor 12 of the reclining unit 10 and the information on the tilting angle C of the seat cushion 3 from the second sensor 22 of the tilting unit 20 (S427).

The control unit 40 may determine whether the first value obtained by adding the support angle B of the seatback 2 and the tilting angle C of the seat cushion 3 is less than the second set allowable value (S428).

If the first value obtained by adding the support angle B of the seatback 2 and the tilting angle C of the seat cushion 3 is less than the second set allowable value, the control unit 40 may confirm whether the operation of the switch module 50 is released (S429). If the operation of the switch module is maintained, the control unit 40 may perform the rear reclining operation of the seatback 2 by allowing the operation of the reclining adjustment motor 11 (S430).

In this case, the control unit 40 may count the number of rotations of the reclining adjustment motor 11 sensed by the first sensor 12 to calculate the angle adjustment amount of the support angle B of the seatback 2 as well as to update the information on the support angle B of the seatback 2.

If the operation of the switch module 50 is released, the control unit 40 may terminate the rear reclining control of the seatback 2.

In addition, or alternatively, if the first value obtained by adding the support angle B of the seatback 2 and the tilting angle C of the seat cushion 3 is greater than or equal to the second set allowable value, the control unit 40 may terminate the rear reclining control of the seatback 2.

As described above, in accordance with the control method according to the fourth example of the present disclosure, the reclining control and the tilting control may be configured to be linked with each other according to the position of the seat for a vehicle, and each of the operation processes may be sequentially or separately performed to limit the angle adjustment amount of the tilting unit 20 or the angle adjustment amount of the reclining unit 10.

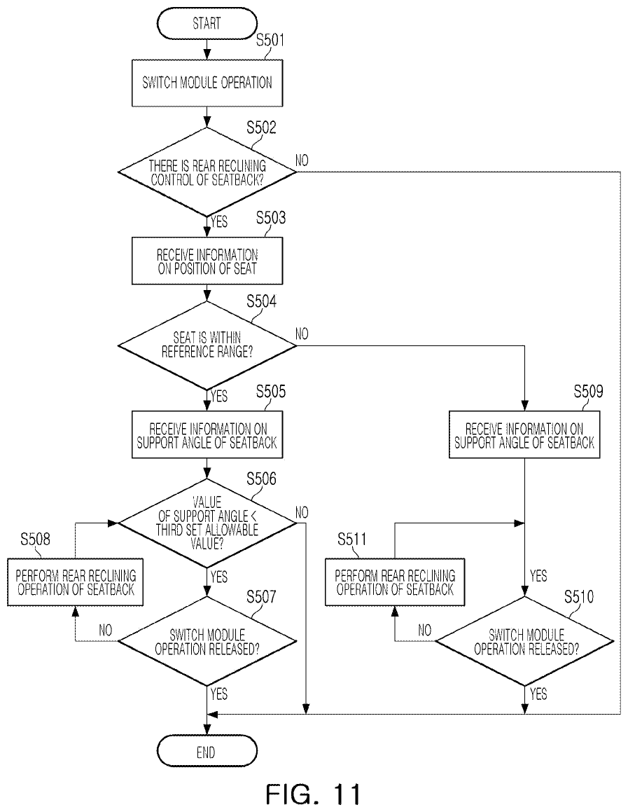

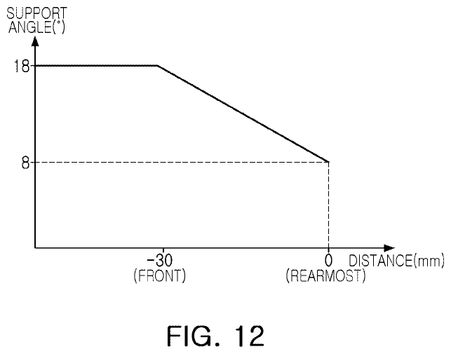

FIG. 11 is a flowchart of a control method according to a fifth example of the present disclosure, and FIG. 12 is a graph for explaining a set allowable value for each position in the control method according to the fifth example of the present disclosure.

The control method in accordance with the fifth example of the present disclosure may limit the angle adjustment amount of the reclining unit 10 by linking the position of the seat with the support angle B of the seatback 2.

To this end, first, the control unit 40 may match and preset the maximum support angle for rear reclining of the seatback 2 corresponding to the position of the seat of a predetermined unit.

In this state, for example, if the passenger operates the switch module 50 to perform the rear reclining control of the seatback 2, the control unit 40 may control the operation of the reclining adjustment motor 11 of the reclining unit 10 within the maximum support angle for rear reclining the seatback 2 matched to the position of the seat sensed by the third sensor 32 of the sliding unit 30.

For example, as illustrated in FIG. 12, if the seat is disposed to the rearmost side, the seatback 2 may be tilted rearward from the reference angle A at a maximum support angle B of 8°. In addition, or alternatively, if the seat is moved and disposed forward by 30 mm from the rearward side, the seatback 2 may be tilted rearward from the reference angle at a maximum support angle of 18°.

The relationship may be expressed in a mathematical equation below.

Y≤{−(Z/3)+8} <Equation 4>

Here, Y is a value of a support angle)(° from the reference angle A of the seatback 2 and is within the range of 0≤Y≤18, and Z is a value of a forward advance distance (mm) from the reference position P as the rearmost position of the seat and is within the range of −30≤Z≤0. Hereinafter, {−(Z/3)+8} is referred to as a third set allowable value, and a range of −30≤Z≤0 is referred to as an interference range.

If the seat is advanced forward by more than 30 mm from the rearmost and deviates from the interference range, for example, since the space between the seatback 2 and the wheelhouse trim 9 of the vehicle body protruding inward may be sufficiently separated, in this case, Y may be subject to a value below a certain constant independent of the position of the seat, that is, a value less than or equal to ‘a maximum value.’

The maximum value is a value of the support angle B at which the seatback 2 can be maximally tilted rearward from the reference angle A, and for example, the seatback 2 may be tilted at a maximum support angle of 18° from the reference angle.

As illustrated in FIG. 11, the passenger manipulates the switch module 50 (S501), and the control operation signal may be input to the control unit 40.

If the control operation of the passenger is input to the control unit 40, the control unit 40 may preferentially determine whether the input control operation is the rear reclining control of the seatback 2 (S502).

If it is determined that the input control operation is the rear reclining control of the seatback 2, the control unit 40 may receive the information on the position of the seat from the third sensor 32 of the sliding unit 20 (S503), and confirm whether the seat is within the interference range from the reference position P as the rearmost position (S504).

For example, the distance within the interference range may be a distance up to 30 mm forward from the reference position P.

If it is confirmed that the seat is within the interference range from the reference position P, the control unit 40 may receive the information on the support angle B of the seatback 2 from the first sensor 12 of the reclining unit 10 (S505).

The control unit 40 may determine whether a second value of the support angle B of the seatback 2 is less than the third set allowable value (S506).

If the second value of the support angle B of the seatback 2 is less than the third set allowable value, the control unit 40 may confirm whether the operation of the switch module 50 is released (S507). If the operation of the switch module 50 is maintained, the control unit 40 may perform the rear reclining operation of the seatback 2 by allowing the operation of the reclining adjustment motor 11 (S508).

In this case, the control unit 40 may count the number of rotations of the reclining adjustment motor 11 sensed by the first sensor 12 to calculate the angle adjustment amount of the support angle B of the seatback 2 as well as to update the information on the support angle B of the seatback 2.

If the operation of the switch module 50 is released, the control unit 40 may terminate the rear reclining control of the seatback 2.

In addition, or alternatively, if the second value of the support angle B of the seatback 2 is greater than or equal to the third set allowable value, the control unit 40 may terminate the rear reclining control of the seatback 2.

On the other hand, if it is confirmed that the seat deviates from the interference range from the reference position P, the control unit 40 may receive the information on the support angle B of the seatback 2 from the first sensor 12 of the reclining unit 10 (S509).

In this case, a value that the support angle B of the seatback 2 to the rear can have is always less than or equal to the maximum value, and accordingly, the control unit 40 may confirm whether the operation of the switch module 50 is released (S510). If the operation of the switch module 50 is maintained, the control unit 40 may perform the rear reclining operation of the seatback 2 by allowing the operation of the reclining adjustment motor 11 (S511).

In this case, the control unit 40 may count the number of rotations of the reclining adjustment motor 11 sensed by the first sensor 12 to calculate the angle adjustment amount of the support angle B of the seatback 2 as well as to update the information on the support angle B of the seatback 2.

If the operation of the switch module 50 is released, the control unit 40 may terminate the rear reclining control of the seatback 2.

As described above, in accordance with the control method according to the fifth example of the present disclosure, the reclining control may be configured to be linked according to the position of the seat for a vehicle, thus limiting the angle adjustment amount of the reclining unit 10 according to the position of the seat.

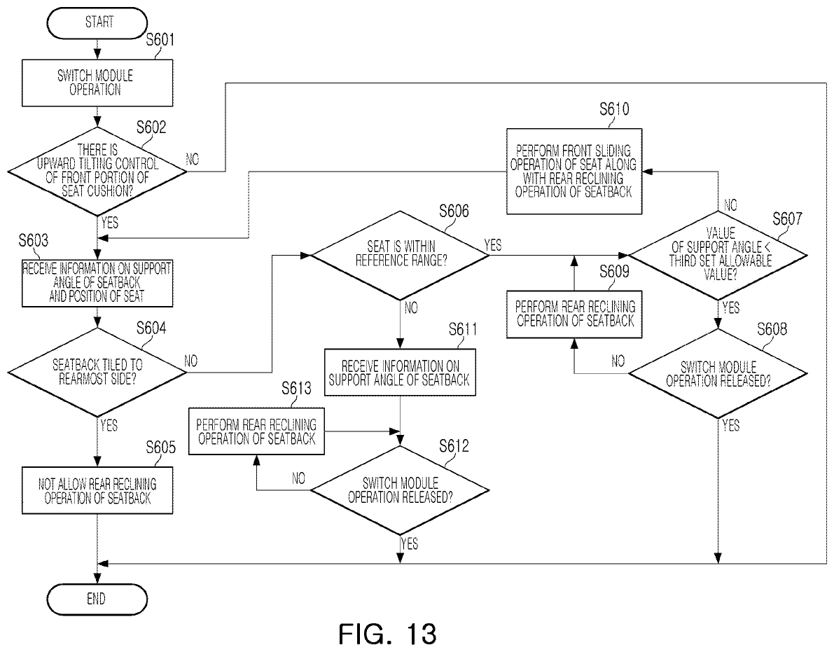

FIG. 13 is a flowchart of a control method according to a sixth example of the present disclosure.

In the control method in accordance with the sixth example of the present disclosure, a priority may be assigned to reclining control if the rear reclining control of the seatback 2 is limited in the position of the seat. In other words, depending the priority, since the sliding unit 30 may be forcibly operated so as to maintain the operation of the reclining unit 10, the seat may be moved forward.

The control method according to the sixth example of the present disclosure illustrated in FIG. 13 is different from the control method according to the fifth example illustrated in FIG. 11 in that the control method in FIG. 13 further includes: confirming whether the seatback 2 is tilted from the reference angle A to the rearmost side; and performing, by the control unit 40, the front sliding operation of the seat along with the rear reclining operation of the seatback 2 if the second value of the support angle B of the seatback 2 is greater than or equal to the third set allowable value. The other constitutions of the control method in FIG. 13 are the same as the control method according to the fifth example illustrated in FIG. 11.

The passenger operates the switch module 50 (S601), and the control operation signal may be input to the control unit 40.

If the control operation of the passenger is input to the control unit 40, the control unit 40 may preferentially determine whether the input control operation is the rear reclining control of the seatback 2 (S602).

If it is determined that the control operation input via the switch module 50 is the rear reclining control of the seatback 2, the control unit 40 may receive the information on the support angle B of the seatback 2 from the first sensor 12 of the reclining unit 10 and the information on the position of the seat from the third sensor 32 of the sliding unit 30 (S603), and may confirm whether the seatback 2 is tilted from the reference angle A to the rearmost side (S604).

If it is confirmed that the seatback 2 is tilted from the reference angle A to the rear most side, the control unit 40 may not allow the rear reclining operation of the seatback 2 without allowing the operation of the reclining adjustment motor 11 of the reclining unit 10 (S605).

If the seatback 2 is not tilted from the reference angle A to the rearmost side, the control unit 40 may confirm whether the seat is within the interference range from the reference position P as the rearmost position (S606).

If it is confirmed that the seat is within the interference range from the reference position P, the control unit 40 may determine whether the second value of the support angle B of the seatback 2 is less than the third set allowable value (S607).

If the second value of the support angle B of the seatback 2 is less than the third set allowable value, the control unit 40 may confirm whether the operation of the switch module 50 is released (S608). If the operation of the switch module 50 is maintained, the control unit 40 may perform the rear reclining operation of the seatback 2 by allowing the operation of the reclining adjustment motor 11 (S609).

In this case, the control unit 40 may count the number of rotations of the reclining adjustment motor 11 sensed by the first sensor 12 to calculate the angle adjustment amount of the support angle B of the seatback 2 as well as to update the information on the support angle B of the seatback 2.

If the operation of the switch module 50 is released, the control unit 40 may terminate the rear reclining control of the seatback 2.

In addition, or alternatively, if the second value of the support angle B of the seatback 2 is greater than or equal to the third set allowable value, the control unit 40 may perform the front sliding operation of the seat by enforcing the operation of the sliding adjustment motor 31, along with the rear reclining operation of the seatback 2 by allowing the operation of the reclining adjustment motor 11 (S610).

Subsequently, the control unit 40 may repeat control from the operation (S603) of receiving the information on the support angle B of the seatback 2 from the first sensor 12 of the reclining unit 10 and the information on the position of the seat from the third sensor 32 of the sliding unit 30.

Meanwhile, if it is confirmed that the seat deviates from the interference range from the reference position P, the control unit 40 may receive the information on the support angle B of the seatback 2 from the first sensor 12 of the reclining unit 10 (S611).

In this case, since the value that the support angle B of the seatback 2 to the rear can have is always less than or equal to the maximum value, and accordingly, the control unit 40 may confirm whether the operation of the switch module 50 is released (S612). If the operation of the switch module 50 is maintained, the control unit 40 may perform the rear reclining operation of the seatback 2 by allowing the operation of the reclining adjustment motor 11 (S613).

In this case, the control unit 40 may count the number of rotations of the reclining adjustment motor 11 sensed by the first sensor 12 to calculate the angle adjustment amount of the support angle B of the seatback 2 as well as to update the information on the support angle B of the seatback 2.

If the operation of the switch module 50 is released, the control unit 40 may terminate the rear reclining control of the seatback 2.

As described above, in accordance with the control method according to the sixth example of the present disclosure, since the reclining control and sliding control of the seat for a vehicle are configured to be linked with each other, the movement adjustment amount of the sliding unit 30 may be enforced according to the angle adjustment amount of the reclining unit 10.

An aspect of the present disclosure is to provide a seat for a vehicle and a method for controlling the same for controlling the seat by linking a tilting angle of a seat cushion and/or a sliding position of the seat with a support angle of a seatback.

According to an aspect of the present disclosure, a seat for a vehicle may include: a reclining unit equipped with a reclining adjustment motor configured to provide driving force for adjusting a support angle of a seatback, and a first sensor configured to sense the support angle of the seatback; a tilting unit equipped with a tilting adjustment motor configured to provide driving force for adjusting a tilting angle of a seat cushion, and a second sensor configured to sense the tilting angle of the seat cushion; a sliding unit equipped with a sliding adjustment motor configured to provide driving force for adjusting front and rear positions of the seat, and a third sensor configured to sense the position of the seat; and a control unit configured to control operations of the reclining unit, the tilting unit, and the sliding unit, wherein the control unit may limit or enforce at least one of an angle adjustment amount of the tilting unit and an angle adjustment amount of the reclining unit by linking at least one of the sensed tilting angle of the seat cushion and the sensed position of the seat with the support angle of the seatback.

The seat for a vehicle may further include a switch module that is operable by a passenger to control an operation of at least one of the reclining unit, the tilting unit, and the sliding unit, and the switch module may be electrically connected to the control unit.

The first sensor may be a hall sensor installed in the reclining adjustment motor, the second sensor may be a hall sensor installed in the tilting adjustment motor, and the third sensor may be a hall sensor installed in the sliding adjustment motor.

The control unit may be configured to match and set a maximum support angle for rear reclining of the seatback corresponding to at least one of the tilting angle of the seat cushion of a predetermined unit and the position of the seat of a predetermined unit.

According to another aspect of the present disclosure, a method for controlling a seat may include: operating a switch module by a passenger; determining whether a control operation of the passenger is upward tilting control of a front portion of a seat cushion or rear reclining control of a seatback; receiving information on a tilting angle of the seat cushion and information on a support angle of the seatback; determining whether a first value obtained by adding the tilting angle of the seat cushion and the support angle of the seatback is less than a first set allowable value; when the first value is less than the first set allowable value, allowing the control operation of the passenger to be performed; and when the first value is greater than or equal to the first set allowable value, terminating the upward tilting control of the front portion of the seat cushion or the rear reclining control of the seatback.

The method for controlling a seat may further include, when the seatback is tilted from the reference angle to the rearmost side, not allowing the upward tilting operation of the front portion of the seat cushion.

The method for controlling a seat may further include, when the seatback is tilted from the reference angle to the rearmost side, not allowing the rear reclining operation of the seatback.

The method for controlling a seat may further include: when it is confirmed that the seat is within the interference range from the reference position, receiving information on the tilting angle of the seat cushion and information on the support angle of the seatback; determining whether the first value obtained by adding the tilting angle of the seat cushion and the support angle of the seatback is less than a second set allowable value; when the first value is less than the second set allowable value, performing the upward tilting operation of the front portion of the seat cushion; and when the first value is greater than or equal to the second set allowable value, terminating the upward tilting control of the front portion of the seat cushion.

The method for controlling a seat may further include: when it is confirmed that the seat is within the interference range from the reference position, receiving the information on the tilting angle of the seat cushion and the information on the support angle of the seatback; determining whether the first value obtained by adding the tilting angle of the seat cushion and the support angle of the seatback is less than a second set allowable value; when the first value is less than the second set allowable value, performing the rear reclining operation of the seatback; and when the first value is greater than or equal to the second set allowable value, terminating the rear reclining control of the seatback.

Before the passenger operates the switch module, a maximum support angle for rear reclining of the seatback corresponding to the tilting angle of the seat cushion of a predetermined unit may be matched and reflected in the first set allowable value, and the maximum support angle for rear reclining of the seatback corresponding to the tilting angle of the seat cushion of a predetermined unit and the position of the seat of a predetermined unit may be matched and reflected in the second set allowable value.

According to another aspect of the present disclosure, a method for controlling a seat may include: operating a switch module by a passenger; determining whether a control operation of the passenger is upward tilting control of a front portion of a seat cushion or rear reclining control of a seatback; receiving information on a tilting angle of the seat cushion and information on a support angle of the seatback; determining whether a first value obtained by adding the tilting angle of the seat cushion and the support angle of the seatback is less than a first set allowable value; when the first value is less than the first set allowable value, allowing the control operation of the passenger to be performed; and when the first value is greater than or equal to the first set allowable value, allowing the control operation of the passenger to be performed and performing a front reclining operation of the seatback or a downward tilting operation of the seat cushion.

The method for controlling a seat may further include, when the seatback is tilted from the reference angle to the rearmost side, not allowing the upward tilting operation of the front portion of the seat cushion.

The method for controlling a seat may further include, when the seatback is tilted from the reference angle to the rearmost side, not allowing the rear reclining operation of the seatback.

Before the passenger operates the switch module, a maximum support angle for rear reclining of the seatback corresponding to the tilting angle of the seat cushion of a predetermined unit may be matched and reflected in the first set allowable value.

According to another aspect of the present disclosure, a method for controlling a seat may include: operating a switch module by a passenger; determining whether a control operation of the passenger is rear reclining control of a seatback; when it is determined that an input control operation is the rear reclining control of the seatback, receiving information on a support angle of the seatback and information on a position of the seat; determining whether the seat is within an interference range from a reference position as a rearmost position; when it is confirmed that the seat is within the interference range from the reference position, determining whether a second value of the support angle of the seatback is less than a third set allowable value; when the second value is less than the third set allowable value, performing a rear reclining operation of the seatback; and when the second value is greater than or equal to the third set allowable value, performing a front sliding operation of the seat along with the rear reclining operation of the seatback.

The method for controlling a seat may further include: when it is confirmed that the seat deviates from the interference range from the reference position, receiving information on the support angle of the seatback; and performing the rear reclining operation of the seatback.

Before the passenger operates the switch module, a maximum support angle for rear reclining of the seatback corresponding to the position of the seat of a predetermined unit may be matched and reflected in the third set allowable value.

According to the examples of the present disclosure as described above, interference between the wheelhouse trim and the seatback may be prevented without changing the shape of the seatback or increasing the cutting amount of the seatback, thereby completely implementing an original function of the seatback and improving the marketability of the seat.

In addition, or alternatively, according to an example of the present disclosure, the configuration is not significantly changed or added, thereby further improving the marketability of the vehicle without significant changes in costs and weight.

The forgoing description is only an example describing a technological scope of the present disclosure, and various changes and modifications may be made by those skilled in the art without departing from the spirit and scope of the present disclosure.

For example, the aforementioned and illustrated examples of the present disclosure may be combined with each other, each of which may optionally further employ or replace some of the components of other examples as needed.

Accordingly, the examples disclosed above and in the accompanying drawings should be considered in a descriptive sense only and not for limiting the technological scope. The technological scope of the present disclosure is not limited by the examples and the accompanying drawings. The spirit and scope of the present disclosure should be interpreted by the appended claims and encompass all equivalents falling within the scope of the appended claims.

What is claimed is:

1. A seat for a vehicle comprising:
a reclining unit comprising:
a reclining adjustment motor configured to provide driving force for adjusting a support angle of a seatback; and
a first sensor configured to sense the support angle of the seatback;
a tilting unit comprising:
a tilting adjustment motor configured to provide driving force for adjusting a tilting angle of a seat cushion, and
a second sensor configured to sense the tilting angle of the seat cushion;
a sliding unit comprising:
a sliding adjustment motor configured to provide driving force for adjusting a position of the seat in a front to rear direction, and
a third sensor configured to sense the position of the seat; and
a control unit configured to control operations of at least one of the reclining unit, the tilting unit, or the sliding unit, by either limiting or enforcing at least one of an angle adjustment amount of the tilting unit or an angle adjustment amount of the reclining unit based on a relation between the support angle of the seatback and at least one of the sensed tilting angle of the seat cushion or the sensed position of the seat.

2. The seat for a vehicle according to claim 1, further comprising:
a switch module configured to enable a passenger to control an operation of at least one of the reclining unit, the tilting unit, or the sliding unit,
wherein the switch module is communicatively connected to the control unit.

3. The seat for a vehicle according to claim 1,
wherein the first sensor comprises a hall sensor associated with the reclining adjustment motor,
the second sensor comprises a hall sensor associated with the tilting adjustment motor, and
the third sensor comprises a hall sensor associated with the sliding adjustment motor.

4. The seat for a vehicle according to claim 1,
wherein the control unit is configured to set a maximum support angle for rear reclining of the seatback based on at least one of the tilting angle of the seat cushion or the position of the seat.

5. A method for controlling a seat, the method comprising:
receiving input indicating a control operation of a switch module;
determining whether the control operation is an upward tilting control operation of a front portion of a seat cushion or a rear reclining control operation of a seatback;
receiving information indicating a tilting angle of the seat cushion and information indicating a support angle of the seatback;
determining whether a first value obtained by adding the tilting angle of the seat cushion and the support angle of the seatback is less than a first set allowable value; and
if the first value is less than the first set allowable value, allowing the control operation to be performed; or
if the first value is greater than or equal to the first set allowable value, terminating the upward tilting control operation of the front portion of the seat cushion or the rear reclining control operation of the seatback.

6. The method for controlling a seat according to claim 5, further comprising:
based on determining the seatback is tilted from a reference angle to a rearmost side, not allowing the upward tilting control operation of the front portion of the seat cushion.

7. The method for controlling a seat according to claim 5, further comprising:
based on determining the seatback is tilted from a reference angle to a rearmost side, not allowing the rear reclining control operation of the seatback.

8. The method for controlling a seat according to claim 5, further comprising:
based on determining that the seat is within an interference range relative to a reference position, receiving information indicating the tilting angle of the seat cushion and information indicating the support angle of the seatback;
determining whether the first value obtained by adding the tilting angle of the seat cushion and the support angle of the seatback is less than a second set allowable value; and
based on the first value being determined to be less than the second set allowable value, performing the upward tilting control operation of the front portion of the seat cushion; or
based on the first value being determined to be greater than or equal to the second set allowable value, terminating the upward tilting control operation of the front portion of the seat cushion.

9. The method for controlling a seat according to claim 5, further comprising:
based on determining that the seat is within an interference range relative to a reference position, receiving the information indicating the tilting angle of the seat cushion and the information indicating the support angle of the seatback;
determining whether the first value obtained by adding the tilting angle of the seat cushion and the support angle of the seatback is less than a second set allowable value; and
based on the first value being determined to be less than the second set allowable value, performing the rear reclining control operation of the seatback; or
based on the first value being determined to be greater than or equal to the second set allowable value, terminating the rear reclining control operation of the seatback.

10. The method for controlling a seat according to claim 8, further comprising, before the receiving the input:
setting the first set allowable value based on a maximum support angle for rear reclining of the seatback corresponding to the tilting angle of the seat cushion; and
setting the second set allowable value based on a maximum support angle for rear reclining of the seatback corresponding to the tilting angle of the seat cushion and a position of the seat.

11. The method for controlling a seat according to claim 9, further comprising, before the receiving the input:
setting the first set allowable value based on a maximum support angle for rear reclining of the seatback corresponding to the tilting angle of the seat cushion; and
setting the second set allowable value based on a maximum support angle for rear reclining of the seatback corresponding to the tilting angle of the seat cushion and a position of the seat.

12. The method for controlling a seat according to claim 5, further comprising, before the receiving the input, setting the first set allowable value based on a maximum support angle for rear reclining of the seatback corresponding to the tilting angle of the seat cushion

13. A method for controlling a seat, the method comprising:
receiving input indicating a control operation of a switch module;
determining the control operation is an upward tilting control operation of a front portion of a seat cushion or a rear reclining control operation of a seatback;
receiving information indicating a tilting angle of the seat cushion and information indicating a support angle of the seatback;
determining whether a first value obtained by adding the tilting angle of the seat cushion and the support angle of the seatback is less than a first set allowable value; and
based on the first value being determined to be less than the first set allowable value, allowing the control operation to be performed; or
based on the first value being determined to be greater than or equal to the first set allowable value, allowing the control operation to be performed and either:
if the control operation is the upward tilting control operation, performing a front reclining operation of the seatback; or
if the control operation is rear reclining control operation, performing a downward tilting operation of the seat cushion.

14. The method for controlling a seat according to claim 13, further comprising:
based on determining the seatback is tilted from a reference angle to a rearmost side, not allowing the upward tilting control operation of the front portion of the seat cushion.

15. The method for controlling a seat according to claim 13, further comprising:
based on determining the seatback is tilted from a reference angle to a rearmost side, not allowing the rear reclining control operation of the seatback.

16. The method for controlling a seat according to claim 13, further comprising, before the receiving the input, setting the first set allowable value based on a maximum support angle for rear reclining of the seatback corresponding to the tilting angle of the seat cushion.

17. A method for controlling a seat, the method comprising:
receiving input indicating operating of a switch module;
determining whether the input indicates a rear reclining control of a seatback;
based on determining that that the input indicates the rear reclining control of the seatback, receiving information on a support angle of the seatback and information on a position of the seat;
determining whether the seat is within an interference range relative to a reference position;
based on determining that the seat is within the interference range relative to the reference position, determining whether a second value of the support angle of the seatback is less than a third set allowable value; and
based on the second value being determined to be less than the third set allowable value, performing a rear reclining operation of the seatback; or
based on the second value being determined to be greater than or equal to the third set allowable value, performing a front sliding operation of the seat along with the rear reclining operation of the seatback.

18. The method for controlling a seat according to claim 17, further comprising:
based on determining that the seat deviates from the interference range relative to the reference position, receiving information on the support angle of the seatback; and
performing the rear reclining operation of the seatback.

19. The method for controlling a seat according to claim 17, further comprising, before the receiving the input, setting the third set allowable value based on a maximum support angle for rear reclining of the seatback corresponding to the position of the seat.
